(19) United States
(12) Patent Application Publication
(10) Pub. No.: US 2018/0368546 A1
(43) Pub. Date: Dec. 27, 2018

(54) PORTABLE EYEGLASS CASE

(71) Applicant: Loreto J. Ceccarelli, Vaughan (CA)

(72) Inventor: Loreto J. Ceccarelli, Vaughan (CA)

(21) Appl. No.: 16/060,843

(22) PCT Filed: Dec. 9, 2016
(86) PCT No.: PCT/CA16/51446

§ 371 Date: Jun. 8, 2018

Related U.S. Application Data
(60) Provisional application No. 62/265,837, filed on Dec. 10, 2015.

(51) Int. Cl. A45C 11/04; G02C 11/00

(52) U.S. Cl. CPC A45C 11/04; G02C 11/00

(57) ABSTRACT

A portable eyeglass case is provided that is convenient to carry, either attached to the eyeglasses or detached. A protective film is provided in the portable eyeglass case. The protective film can be expanded to cover and protect the lenses of the eyeglasses when needed and retracted into the case for easy carrying when the portable eyeglass case is not in use. A logo can be printed on the protective film and the logo will be shown when the portable eyeglass case is in use.

### CROSS-REFERENCE TO RELATED APPLICATION

This application claims priority to and the benefit of U.S. Provisional Patent Application No. 62/265,837 filed Dec. 10, 2015, the contents of which are incorporated herein by reference.

### TECHNICAL FIELD

This invention relates to a protective case for eyeglasses, in particular, a portable protective case for eyeglasses.

### BACKGROUND

Eyeglasses are necessary in the daily lives of billions of people. According the Vision Council of America, in the United States alone, three quarters of the population uses vision correction and 64% of the population wears eyeglasses.

With the prevalent use of eyeglasses, naturally comes the problem of protecting the lenses of the eyeglasses because the optical quality of the eyeglasses degrades once the lenses are scratched.

This problem is heightened with the rising prices of eyeglasses. In North America, a pair of eyeglasses can easily cost hundreds of dollars. Therefore, for many people, it is necessary to protect the eyeglasses to prolong their usable life.

Eyeglasses are typically protected using eyeglass cloth and protective cases. However, the protective cases are unwieldy, big and inconvenient to carry around. The result is people do not bring the protective cases with then, leaving the eyeglasses unprotected when they are not in use. Consequently, the eyeglasses are scratched faster and replacement eyeglasses are required more often.

To solve this problem, the present invention provides a portable eyeglass protective case that can be easily carried.

### SUMMARY

The present invention provides a portable protective case for eyeglasses that can be attached to the eyeglasses. This way, users of eyeglasses are more likely to carry the protective case with them, so that the eyeglasses can be protected when they are not in use.

In some example aspects, the present invention provides a retractable protective film held in a portable eyeglass case, the portable eyeglass case being able to attach to one temple of the eyeglasses. One end of the retractable protective film is attached to a container that is a part of the portable eyeglass case, while the other end of the retractable protective film is movable, and is provided with an attachment means that can attach to the side of the eyeglass frame away from the temple to which the container is attached. When the protective case is in use, the retractable protective film is expanded and the movable end is attached to the side of the eyeglass frame (or the lens in the case of frameless eyeglasses) away from the temple to which the container of the portable eyeglass case is attached. When the film is expanded, with one end attached to the container and the other end attached to the side of the eyeglass frame away from the temple to which the container is attached, the film fully covers the lenses of the eyeglasses, thus the lenses of the eyeglasses are protected.

In some example aspects, the present invention provides a portable eyeglass case with a rotatable container containing the protective film. In some example aspects, the present invention provides a portable eyeglass case with a fixed container containing the protective film.

In some example aspects, the present invention provides a retractable protective film held in a container, the container being rotatably attached to one temple of the eyeglasses. When the user is ready to use the protective case, the container is rotated to a position suitable for use, and then the retractable protective film is pulled from the container to cover the lenses.

In some example aspects, logos, decorative arts or advertisements are printed on the protective film so that when the protective film is expanded, the arts, etc., are shown.

### BRIEF DESCRIPTION OF THE DRAWINGS

Reference will now be made to the drawings, which show by way of example embodiments of the present disclosure, and in which:

FIG. 1 shows a pair of eyeglasses with a portable eyeglass case attached, wherein the portable eyeglass case is in a standby position.

FIG. 2 shows a pair of eyeglasses with a portable eyeglass case attached, wherein the portable eyeglass case is in a ready-to-use position.

FIG. 3 shows when the portable eyeglass case is in use with the logo printed on the protective film shown.

FIG. 4 shows a portable eyeglass case detached from the eyeglasses.

It will be noted that throughout the appended drawings, like features are identified by like reference numerals.

### DETAILED DESCRIPTION

The present disclosure provides examples of portable protective cases for eyeglasses.

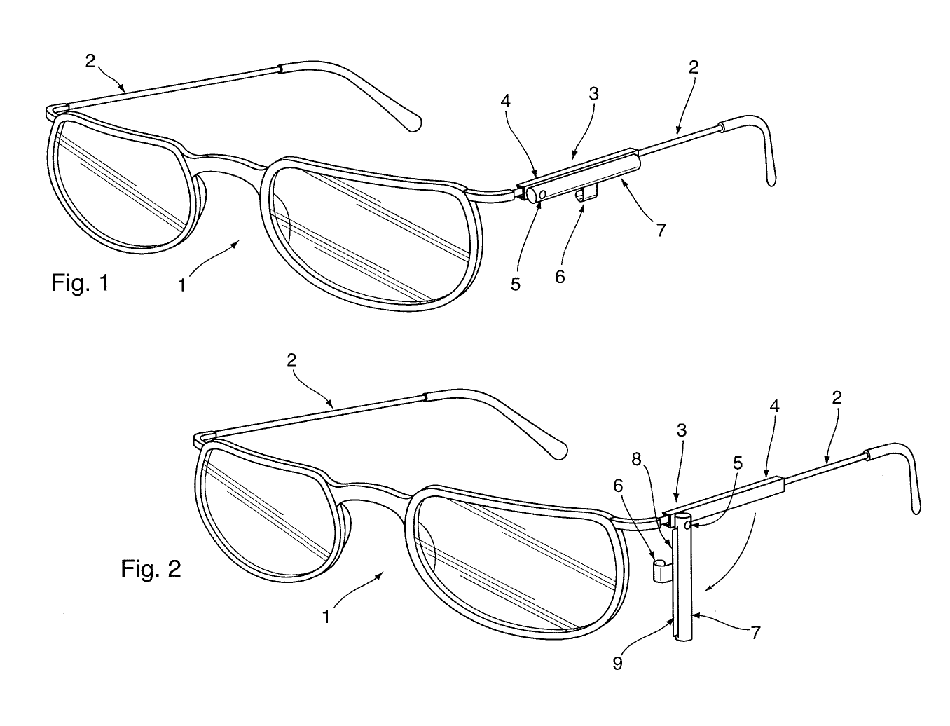

FIG. 1 shows a pair of eyeglasses 1 comprising a pair of lenses and a pair of foldable arms, referred to herein as temples 2. Also shown in FIG. 1 is a portable eyeglass case 3 comprising a container 7 containing a protective film 8, wherein the eyeglass case 3 is in the standby position. The portable eyeglass case 3 is attached to one of the temples 2 by an attachment means 4. Any suitable attachment means known in the field is contemplated in this disclosure. In some instances, the attachment means 4 can be a bracket. In some other instances, the attachment means 4 can be a tunnel shaped elastic material or structure that can slide onto a temple by threading the free end of the temple through the tunnel, in a way similar to attaching neck straps to sunglasses. It will be appreciated that the structure of the attachment means will vary according to the structure of the temples 2.

In other embodiments, the eyeglass case 3 can be integrally formed with, and directly connected to, one of the temples 2, such that discrete attachment means 4 are not required.

The container 7 is hollow so as to accommodate the protective film 8. The container 7 can be any suitable shape and size. In some embodiments the protective film 8 will be stored inside the container 7 in the form of a cylindrical roll, with the container 7 comprising an elongate hollow tube having any desired cross-sectional shape, including circular or square. However, the cross-section of the tube is not limited to these shapes, and may have any rounded or polygonal shape.

The container 7 has a length sufficient to store a film having a height sufficient to substantially completely cover the lenses of the eyeglasses 1 from the top to the bottom of the lenses. For example, the container may be about 1″ to 1.5″ in length, depending on the size of the lenses to be protected. The width of the container 7 is preferably smaller than the length of the container 7, such that the container 7 is compact and not noticeable in the standby position. For example, the width of the container is more preferably between about 0.2″ to 1″, depending on the structure of the temples 2.

The container 7 is rotatably attached to the attachment means 4 through a pivoting means 5, which may comprise a pivot pin projecting from the attachment means 4. In other embodiments, the pivoting means 5 may be integrally formed with the temple 2. The length direction of the container 7 is approximately parallel with the length direction of the temple 2 when the portable eyeglass case 3 is in the standby position. Although the drawings show a pivoting means 5 in the form of a simple pivot pin, it will be appreciated that the pivoting means 5 may comprise any suitable means to rotatably attach the container 7 to the attachment means 4 or to the temple 2.

Preferably, resistance is provided so that when the user does not rotate the container 7, the container 7 stays in the standby position as shown in FIG. 1. In some instances, friction can be provided between the container 7 and the attachment means 4, and/or a snap mechanism may be provided to keep the container 7 in the standby position when not in use.

FIG. 2 shows the container 7 in a ready-to-use position, wherein the length direction of the container 7 is about perpendicular to the length direction of the temple 2. The container 7 and/or the attachment means 4 may include a stop mechanism to prevent over-rotation of the container 7 past the ready-to-use position. Any suitable means known in the field is contemplated in this disclosure. For example, a pin can be designed in the protective case to block the container from rotating more than a desired angle so that the container will not be pulled out of position when the exposed end of the protective film 8 is attached to the side of the eyeglasses frame away from the side to which the container 7 is attached. Also, a detent or other mechanism may be provided to prevent the container 7 from rotating back to the standby position without assistance from the user. Preferably, means is provided to limit the angle of rotation of the container 7.

The container 7 has a slit opening 9 extending along its length through which the protective film 8 is pulled out from the container 7 by unwinding. The length direction of the opening 9 is approximately parallel to the length direction of the container 7. One end of the protective film 8 is attached to the hollow interior of the container 7 and is not shown, while the opposite end of the protective film 8 is exposed outside of the container 7 through the opening 9 so that a user can hold the end to pull out the protective film 8. A releasable securing means 6 is provided at the exposed end of the protective film 8.

In some instances, the rotation of the container 7 can be limited to only one direction, thus the portable eyeglass case 3 can only be attached to a particular temple 2 of the eyeglasses. In some other instances, the rotation can be allowed in more than one direction, such that the portable eyeglass case 3 can be attached to either temple 2 of the eyeglasses.

In some instances, the ready-to-use position is the same as the standby position, wherein the length direction of the opening 9 on the container 7 is largely parallel to the length direction of the temple 2. In these instances, the means 5 is not needed. The attachment means 4 and the container 7 can be made into a one-piece portable eyeglass case. The protective film 8 can be of a shape that covers the lenses when the protective film 8 is expanded from this position. For example, the protective film 8 can be arc-shaped. The protective film 8 can also be arc-shaped with a segment of it cut off so that the protective film 8 does not significantly protrude beyond the bottom of the lenses.

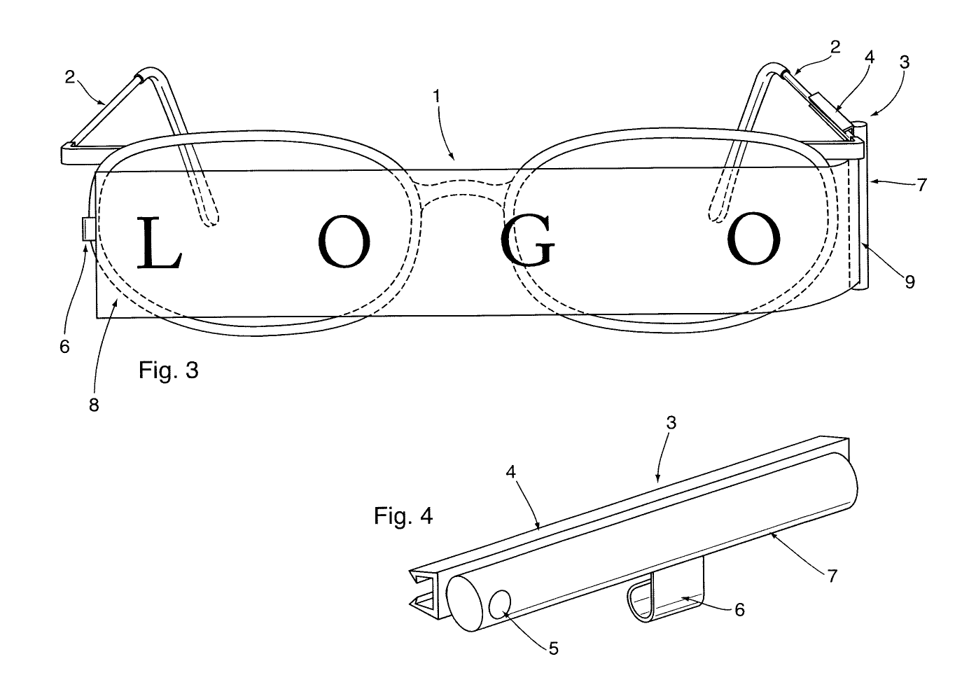

FIG. 3 shows the protective case 3 when it protects the lenses of the eyeglasses 1. The protective film 8 is pulled out of the container 7 and covers the lenses.

Releasable securing means 6 provided on the exposed end of the protective film 8 is attached to the side of the eyeglasses (i.e. attached to the frame or lens) away from the container 7, holding the protective film 8 in position to protect the lenses. The protective film 8 is preferably sized to cover the lenses.

The protective film 8 can be made of any flexible material. The material is preferably selected from soft materials so that the protective film 8 will not scratch the lenses of the eyeglasses. The material is preferably selected from cloth, leather, plastic and elastomers. The side of the protective film 8 that is in contact with the lenses of the eyeglasses when the protective case is in use can additionally or alternatively be lined with a soft material, which is preferably selected from fleece, microfiber, leather, velvet and felt.

In some examples, logos, arts, or other decorative patterns are printed on the protective film 8 and can be shown when the protective film 8 is expanded.

The releasable securing means 6 provided on the exposed end of the protective film 8 that is not attached to the container can be any suitable means known in the field. For example, the releasable securing means 6 can be a clip or hook capable of attaching to a temple 2 or other parts of the eyeglasses frame on the side of the eyeglasses 1 away from the temple 2 that the container 7 is attached to.

A retracting mechanism is preferably incorporated into the container 7 so that the protective film 8 automatically retracts into the container 7 when then exposed end of the protective film 8 is released, similar to a window blind.

FIG. 4 shows a detached portable eyeglass case 3 in the standby position. The example shown here has an attachment means 4 capable of attaching to a temple 2 of a pair of eyeglasses 1. In some examples, the portable eyeglass case 3 can be attached to the eyeglasses 1 at all times because of the small size of the portable eyeglass case 3. When the user is ready to use the portable eyeglass case 3, the user simply needs to rotate the container 7, pull out the protective film 8, and attach the exposed end of the protective film 8 to the side of the eyeglasses away from the container 7. In the instances that the standby position is the same as the ready-to-use position, as described above, even the rotating step is omitted.

In some other examples, the portable eyeglass case 3 can be carried by the user separately. For example, the user can attach the portable eyeglass case 3 to the keychain or similar items. When the user is ready to use it, the user can then attach the portable eyeglass case to a temple 2 of the eyeglasses 1 by the attachment means 4. In some instances, the container is rotatable so that the user needs to rotate the container into the ready-to-use position. In some other instances, the portable eyeglass case 3 is designed such that it is in the ready-to-use position when attached, eliminating the need for rotation. In some examples, instead of having the length direction of the container 7 in a position about parallel to the length direction of the temple 2, the container 7 can be in a position where the length direction of the container is about perpendicular to the length direction of the temple 2, i.e., in the ready-to-use position when attached. For instance, when the attachment means 4 is a bracket, the bracket can be positioned so that the groove of the bracket is largely perpendicular to the length direction of the container 7. Thus, when the portable eyeglass case 3 is attached to a temple 2, the opening 9 on the container is largely perpendicular to the length direction of the temple 2. In some other examples, the portable eyeglass case 3 is attached such that the length direction of the container 7 is about parallel to the length direction of the temple 2, with the protective film 8 shaped that it can be pulled out to protect the lenses of the eyeglasses. For example, the protective film 8 can be arc-shaped. The protective film 8 can also be arc-shaped with a segment of it cut off so that the protective film 8 does not significantly protrude beyond the bottom of the lenses.

Although the description and drawings illustrate one embodiment of the portable eyeglass case 3 for attachment to a specific pair of eyeglasses 1, it will be appreciated that the portable eyeglass case 3 and its attachment means 4 are adaptable for use with any type of eyeglasses having any temple design and shape, whether the temples are made from metal, plastic or other material, and whether the temples are rigid or flexible. Also, as mentioned above, the portable eyeglass case 3 may form an integral part of the eyeglasses, such that it does not include a discrete attachment means 4, with the attachment means being integrally formed with one of the temples 2.

1. An apparatus for protecting a pair of eyeglasses comprising a pair of lenses and a pair of temples, the apparatus comprising:
a container having a hollow interior, the container being adapted for attachment to a first temple;
a film having a first end secured within the hollow interior of the container, wherein the film is stored within the hollow container with the apparatus in a standby position, with a second end of the film extending outside the hollow interior when the apparatus is in the standby position, wherein the film is adaptable to substantially cover the lenses;
a releasable securing means disposed on the second end of the film and adapted for attachment to one of the lenses of the eyeglasses, distal to the first temple;
wherein the film is adapted to be partially withdrawn from the hollow interior of the container when in use, such that the first end of the film remains secured within the hollow interior and the releasable securing means is attached to the distal lens of the eyeglasses.

2. The apparatus according to claim 1, wherein the container includes a slit opening through which the film is withdrawn.

3. The apparatus according to claim 1, wherein the film is retractable into the hollow interior of the container.

4. The apparatus according to claim 3, further comprising a retracting means for retracting the film into the interior of the container.

5. The apparatus according to claim 1, wherein the film is stored within the hollow container in the form of a roll.

6. The apparatus according to claim 1, wherein the film has an outer surface and an inner surface, wherein the inner surface is adapted for contact with the lenses of the eyeglasses and the outer surface of the film is provided with a design and/or printed indicia.

7. The apparatus according to claim 6, wherein the inner surface is made of a material selected from fleece, microfiber, leather, velvet or felt.

8. The apparatus according to claim 6, wherein the outer surface is made of a material selected from cloth, leather, plastic or elastomers.

9. The apparatus of claim 6, wherein the outer surface is printed thereon logos, arts, or other decorative patterns.

10. The apparatus according to claim 1, wherein the releasable securing means is a hook or a clip.

11. The apparatus according to claim 1, wherein the container comprises an elongate tube having first and second ends.

12. The apparatus according to claim 11, further comprising:
an attachment means adapted to be secured to the first temple, wherein the first end of the tube is secured to the attachment means.

13. The apparatus according to claim 12, wherein the attachment means is a tunnel made with an elastic material or a bracket.

14. The apparatus according to claim 12, wherein the first end of the tube is rotatably secured to the attachment means.

15. The apparatus according to claim 14, wherein a means is provided for limiting the angle of rotation of the tube relative to the attachment means.

16. The apparatus according to claim 15, wherein the means for limiting the angle of rotation is a pivot pin or a detent.

17. The apparatus according to claim 14, further comprising a holding means for preventing autonomous rotation of the tube.

18. The apparatus according to claim 14, wherein the container is substantially parallel to the first temple in the standby position, and is substantially perpendicular to the first temple in a ready-to-use position, and wherein the container is rotated about the first end in order to move it from the standby position to the ready-to-use position.
